(19) United States
(12) Patent Application Publication
(10) Pub. No.: US 2019/0060960 A1
(43) Pub. Date: Feb. 28, 2019

(54) DEVICE FOR CLEANING MILL ROLLERS, AND METHOD OF USE

(71) Applicant: MEDISCA PHARMACEUTIQUE INC., St-Laurent (CA)

(72) Inventors: Vargha TALEBI, Ottawa (CA); Vance BAO, St-Laurent (CA); Lyman LI, San Diego, CA (US)

(73) Assignee: MEDISCA PHARMACEUTIQUE INC., St-Laurent (CA)

(21) Appl. No.: 16/106,874

(22) Filed: Aug. 21, 2018

Related U.S. Application Data
(60) Provisional application No. 62/548,714, filed on Aug. 22, 2017.

(51) Int. Cl. B08B 1/02; B02C 4/02; B08B 3/04

(52) U.S. Cl. CPC B08B 1/02; B02C 4/30; B08B 3/04; B02C 4/02

(57) ABSTRACT

A cleaning tool for cleaning rollers of a mill, which comprises a body with an underside defining a plurality of curved channels and an attachment assembly to releasably secure a cleaning element to the body so as to cover the underside thereof when secured. Also, a method of cleaning a plurality of rollers of an ointment mill, which comprises attaching a cleaning element to a cleaning tool with an underside having curved channels conforming to a surface of the rollers; pressing the cleaning tool against the rollers to cause the cleaning element to capture residue from the rollers; removing the cleaning element from the cleaning tool; and attaching a new cleaning element to the cleaning tool for re-use of the cleaning tool.

### CROSS-REFERENCE TO RELATED APPLICATION

The present application claims the benefit under 35 U.S.C. 119(e) of U.S. Provisional Patent Application 62/548714, filed on Aug. 22, 2017, which is hereby incorporated by reference herein.

### FIELD

The present application relates to a cleaning device and, more particularly, to a device for cleaning rollers of a mill and a related method of use.

### BACKGROUND

Milling technology is used across various industries, wherever there is need to crush particles. For example, mills may be used in industries such as pharmaceutical compounding, cosmetics, food processing, electronics and nano-materials. One example of a mill is an ointment mill which may be used by compounding pharmacists to reduce particle size of an active pharmaceutical ingredient and create a more homogeneous and effective preparation in the form of an ointment, cream, gel or paste.

A mill often includes a set of parallel rollers. When a milling cycle is finished, residue remains on the rollers. A problem arises with cleaning the rollers, especially rollers that are permanently fixed to the mill. In particular, present techniques for cleaning the rollers are unsatisfactory.

Thus, a solution to this problem would be welcomed by the industry.

### SUMMARY

Embodiments of the presently described device may provide a user with an easy-to-use, fast, and affordable way of cleaning rollers of a mill, in particular fixed rollers. The device may clean all rollers simultaneously, while applying little force. Contact with the rollers is made by a cleaning element such as a microfiber cloth under a cleaning tool. The cleaning element may be releasably attached to the cleaning tool and may in some cases be machine washable and reusable.

Thus, according to a first aspect, there is provided a cleaning tool for cleaning rollers of a mill, comprising: a body with an underside defining a plurality of curved channels; and an attachment assembly to releasably secure a cleaning element to the body so as to cover the underside thereof when secured.

According to a second aspect, there is provided a device for cleaning rollers of a mill, comprising: a cleaning tool comprising a body; a cleaning element configured to conform to a shape of a top portion of the rollers; and an attachment assembly to releasably secure the cleaning element to the body so as to cover an underside thereof when secured.

According to a third aspect, there is provided a method of cleaning a plurality of rollers of an ointment mill, comprising: attaching a cleaning element to a cleaning tool with an underside having curved channels conforming to a surface of the rollers; pressing the cleaning tool against the rollers to cause the cleaning element to capture residue from the rollers; removing the cleaning element from the cleaning tool; and attaching a new cleaning element to the cleaning tool for re-use of the cleaning tool.

According to a fourth aspect, there is provided a device for cleaning rollers of a mill, comprising: a cleaning tool comprising a body with an underside; a cleaning element with an upper surface and a lower surface; and an attachment assembly to releasably secure the upper surface of the cleaning element against the underside of the body; wherein the lower surface of the cleaning element defines a plurality of curved channels when the upper surface of the cleaning element is secured against the underside of the body.

According to a fifth aspect, there is provided a kit, comprising: a mill comprising a plurality of parallel rollers with an exposed portion; and a cleaning tool with a releasably securable cleaning element, the cleaning element having a lower portion with a shape corresponding to a shape of the exposed portion of the rollers.

### BRIEF DESCRIPTION OF THE DRAWINGS

FIG. 1 is a perspective view of a cleaning tool in accordance with an embodiment, including a handle.

FIG. 2 is a further perspective view of a cleaning tool in accordance with an embodiment, without a handle.

FIG. 3 is a perspective view of a handle for use with the cleaning tool, in accordance with an embodiment.

FIG. 4 is a top view of the cleaning tool of FIG. 2.

FIG. 5 is a front elevation view of the cleaning tool of FIG. 2.

FIG. 6 is a side elevation view of the cleaning tool of FIG. 2.

FIGS. 7A, 7B, 7C are views of a cleaning element for use with the cleaning tool of FIGS. 1, 2 and 4-6.

FIGS. 8A, 8B, 8C show steps in attaching the cleaning element of FIGS. 7A-7C to the cleaning tool of FIGS. 1, 2 and 4-6, resulting in a device shown in FIG. 8C when attachment is complete.

FIG. 9 is a perspective view of an exemplary mill with rollers that can be cleaned by the device of certain embodiments.

FIG. 10 is a flowchart illustrating steps in a method of using the cleaning tool and the cleaning element described herein, in accordance with an embodiment.

FIG. 11 is a front elevation view of a cleaning tool in accordance with an alternative embodiment.

### DETAILED DESCRIPTION

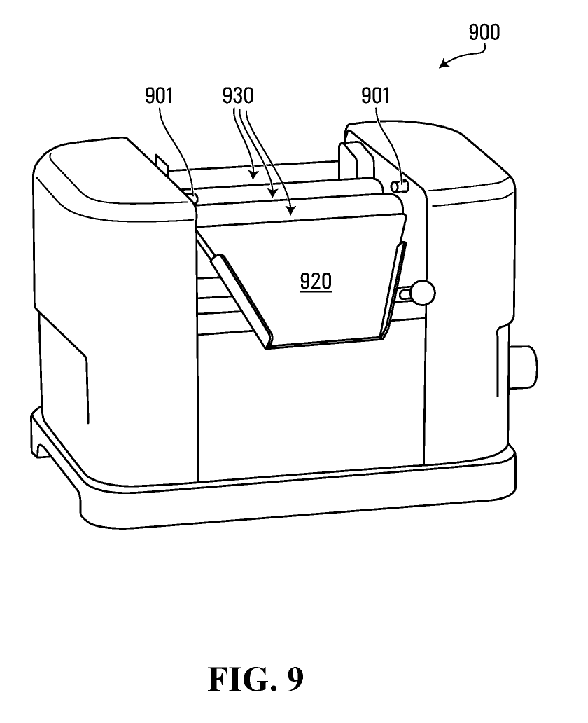

FIG. 9 shows an ointment mill 900 with an apron 920 and plurality of rollers 930, in this case three (3) rollers. A hopper (not shown) may also be provided. The rollers 930 have an inter-roller spacing (i.e., a gap) that may be adjustable. The gap between the rollers 930 ensures uniform particle size, and in the process of reducing the particle size, dispersion and homogenization of the powder in the compound are enhanced. The rollers 930 may be permanently fixed to the body of the ointment mill 900, or they may be removable jointly as a unit/cartridge, or they may be individually removable. Having fixed rollers may enable a finer calibration of the gap settings, therefore a better quality end product.

A non-limiting example of an ointment mill that may be suitable for use in certain embodiments is the T50 ointment mill from Torrey Hills Technologies, LLC of San Diego, Calif. Certain parameters of the T50 ointment mill are as follows:
Roller Material: Ceramic (Alumina)
Diameter of Roller: 2″ (50 mm)
Length of Roller: 7″ (178 mm)
Speed of Roller: Slow Roller: 0˜219 RPM
   Middle Roller: 0˜394 RPM
   Fast Roller: 0˜723 RPM.

However, it should be appreciated that embodiments of the present invention are not limited to the use of this ointment mill in particular or even ointment mills in general, as they can be used with mills in a variety of industries where the rollers may be made of different materials (e.g., steel, ceramic) for different applications.

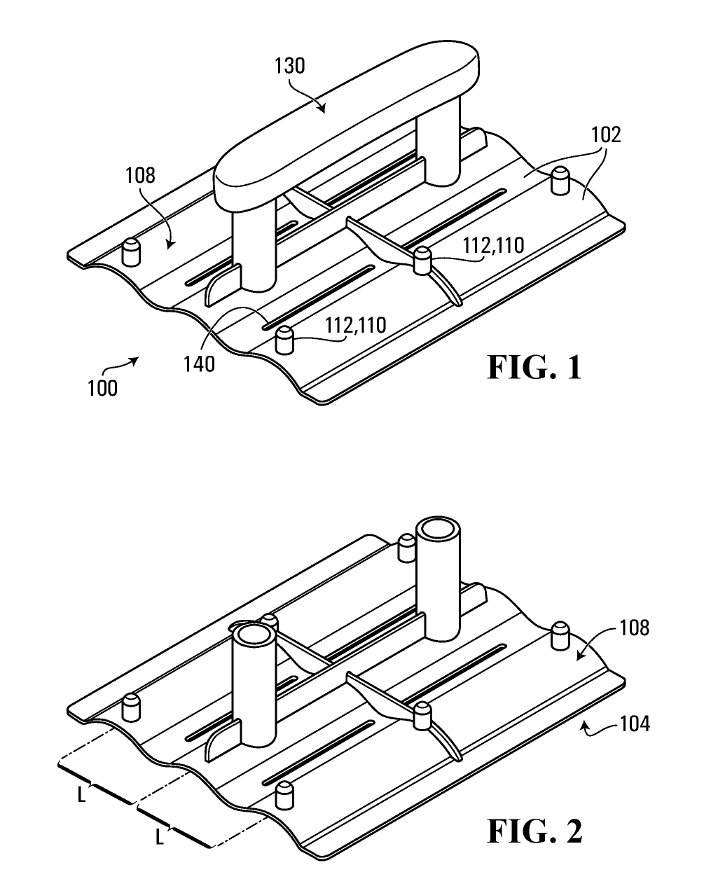

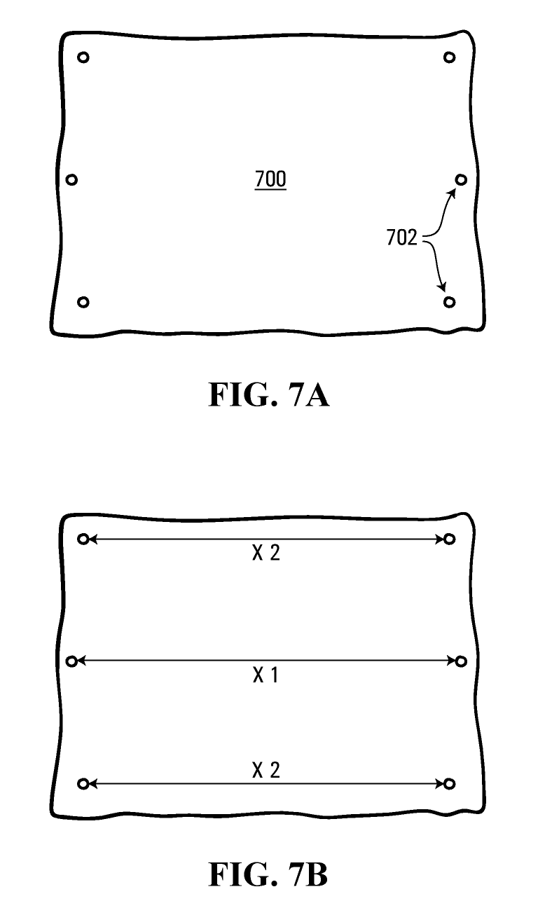

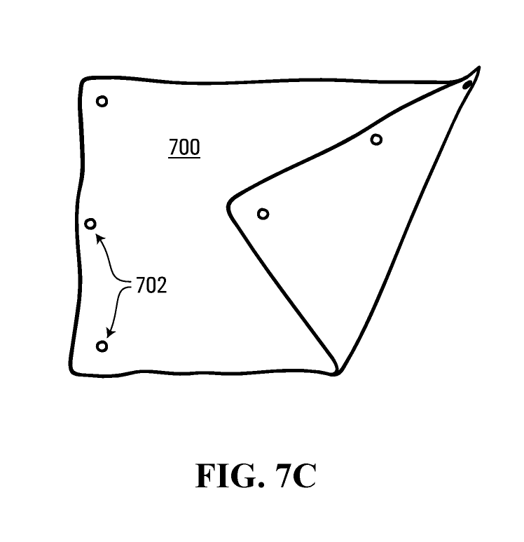

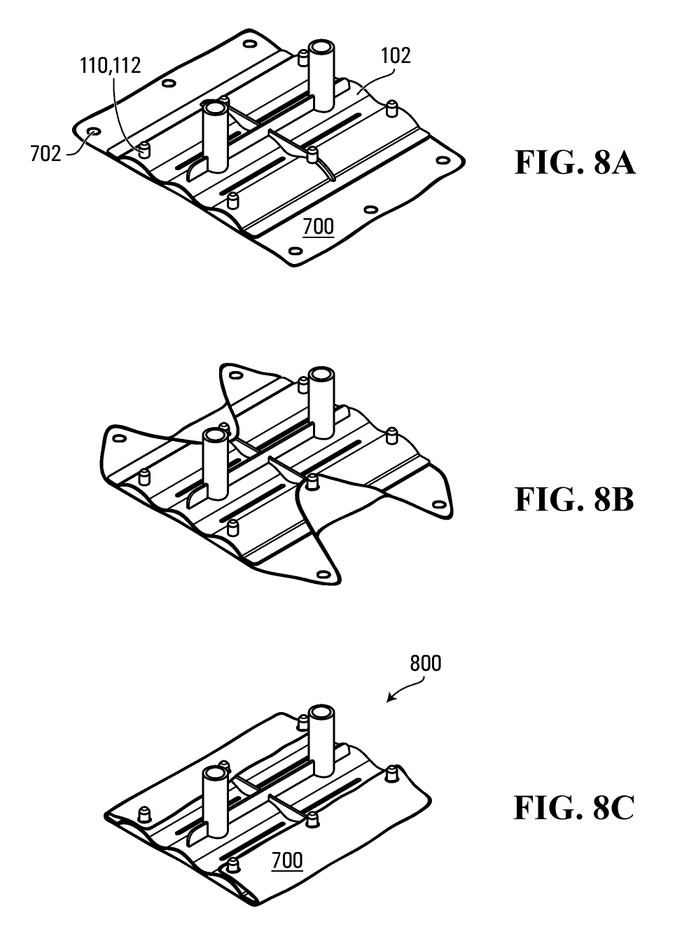

To clean rollers of a mill, such as the rollers 930 of the ointment mill 900 of FIG. 9, a device may be used that includes a cleaning tool and a cleaning element that may be releasably securable to the cleaning tool. The cleaning tool 100 appears in FIGS. 1 to 6, and the cleaning element 700 appears in FIGS. 7A to 7C. The cleaning element 700 is attached to the cleaning tool 100. Steps in attachment of the cleaning element 700 to the cleaning tool 100 are shown in FIGS. 8A to 8C, with a fully assembled device 800 shown in FIG. 8C. The device 800 is pressed against the portion of the rollers 930 that is exposed, which helps to remove residue as the rollers 930 continue to roll.

Reference is now made to FIGS. 1, 2 and 4-6, which show the cleaning tool 100 in greater detail. The cleaning tool 100 comprises a body 102 with an underside 104 defining a plurality of curved channels 106, in this case three curved channels 106 corresponding to the number of rollers of the ointment mill with which it is to be used. The body 102 also has an upper side 108 opposite the underside 104. The body 102 may be made of plastic, for example, or of another material such as metal or composite.

Reference is also made to FIGS. 7A to 7C, which show the cleaning element 700 in greater detail. In this embodiment, the cleaning element 700 may be soft and/or flexible so as to conform to the channels 106 on the underside 104 of the body 102.

The cleaning tool 100 comprises an attachment assembly 110 to releasably secure the cleaning element 700 to the body 102. A more detailed explanation of the attachment assembly 110 is now provided. In this regard, it is noted that the attachment assembly 110 may comprise at least one component that is affixed to the body 102, such as to the upper side 108 of the body 102. In the present embodiment, the at least one component comprises a plurality of spaced pegs 112 on the upper side 108 of the body 102. The pegs 112 cooperate with holes 702 in the cleaning element 700 that are formed near certain edges of the cleaning element 700, as best seen in FIGS. 8A, 8B and 8C. As such, in this example, the cleaning element 700 is greater in surface area than the underside 104 of the body 102, and this allows the cleaning element 700 to fold over the periphery of the body 102, whereas the holes 702 are configured to be lined up with the pegs 112 so that the pegs 112 fit therein.

Since the cleaning element 700 is largely underneath the body 102, and so long as the cleaning element 700 is relatively snugly fitting when the holes 702 receive the pegs 112 of the cleaning element 700, the pegs 112 keep the cleaning element 700 in place during use. In some embodiments, there may be four (4) holes 702 in the cleaning element 700 with four (4) matching pegs 112 on the body 102, or six (6) holes 702 in the cleaning element 700 with six (6) matching pegs 112 on the body 102, although there may be a differing number of holes and pegs. Also, the pegs 112 may be distributed in such a way that if the upper side 108 of the body 102 were divided into a matrix of 4×4 parts of equal area, each of the four extreme corners of the matrix would include one, or at least one, of the pegs 112.

In the case where there are six holes 702, and with particular reference to FIG. 7B, the holes 702 may occupy top, middle and bottom positions of a left portion, and top, middle and bottom positions of the right portion, of the cleaning element 700. The distance between the top holes may be denoted X2. The distance between the bottom holes may also correspond to X2, while the distance between the middle holes may be X1, which may, but need not, be greater than X2. In a non-limiting embodiment, X2 may be 25.5 cm (255 mm) while X1 may be 26.0 cm (260 mm). Any existing difference between X2 and X1 (in this case 5 mm, but in other cases there may be a difference of at least 1 mm, or between 1 mm and 10 mm, etc.) may make the fit of the cleaning element 700 somewhat tighter around the corners of the cleaning tool 100 than around the center pegs. In this embodiment, which is not limiting, it should be noted, the three pairs of pegs have equal spacing (“X3”, not shown) of X1 or slightly more than X1, with the cleaning element 700 being stretchable to compensate for the difference between X3 and X1 and between X3 and X2.

Alternative realizations of the attachment assembly 110 may include fewer components attached to the body 102. For example, an alternative attachment assembly could be a connector that attaches different parts of the cleaning element 700 together and over the body 102 of the cleaning tool 100, without being attached to the body 102 of the cleaning tool 100 at all. Still other embodiments involve the use of hooks, clips, a location on the body 102 configured to pinch the cleaning element 700 when it is inserted therein, an insert guard rail, as well as other configurations. An example of a connector could be a safety pin or a device having two components attaching to respective parts of the cleaning element 700.

It should be appreciated that to minimize potential damage to the rollers 930, the attachment assembly 110 may be free from any component protruding from the underside 104 of the body 102.

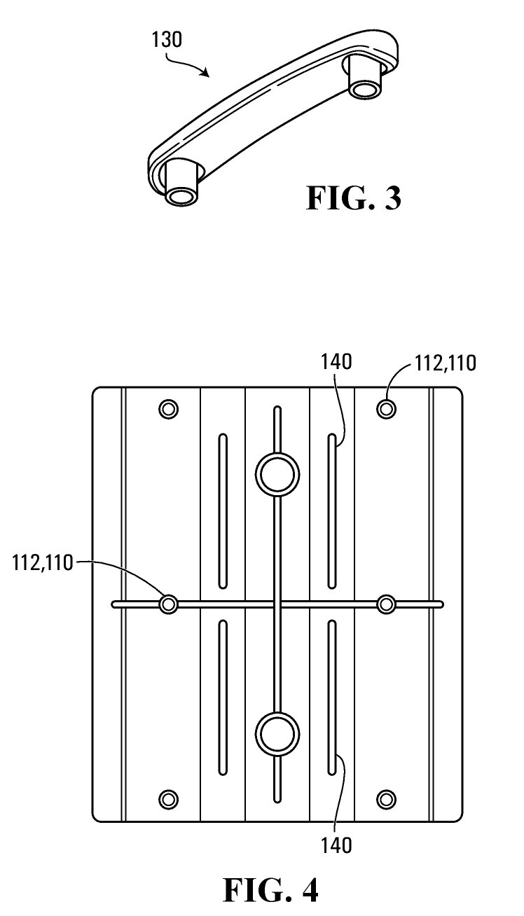

To facilitate use of the cleaning tool 100, a handle 130 may be attached to the body 102, in particular to the upper side 108 of the body 102. The handle 130 is best seen in FIGS. 1 and 3. The handle 130 may be made of the same material as other parts of the body 102, but this is not a requirement. The handle 130 may be detachable from the body 102 or permanently fastened thereto.

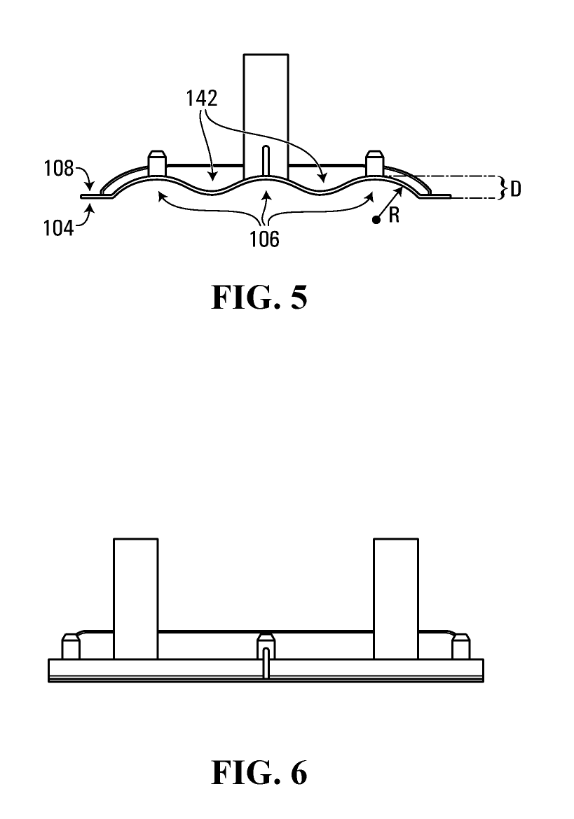

Clearly, for use with rollers that are all in the same plane, the channels 106 on the underside 104 of the body 102 may all be in the same plane, as well as being parallel to one another. Also, for use with identically sized rollers, each of the channels may have a common radius of curvature R. Moreover, the radius of curvature R of the channels 106 may be equal or greater than the radius of curvature of the rollers 930 they are configured to fit to. As for a depth D of a particular one or more of the channels 106, measured in a height direction, this may be anywhere from a quarter of the radius of curvature R (of the respective channel) to half the radius of curvature R, all the way to close to the radius of curvature R itself, such as 95% of the radius of curvature R or even more. A full half-circle may thus be used in some embodiments, but in other embodiments the channels may cover only a small fraction of a circular underside 104 of the body 102. In some cases, at least part of the body 102 may have a sinusoidal cross section, as seen in FIG. 5, which would occur with a depth that is half of the radius of curvature R.

In other instances, the rollers need not be parallel, and need not be of the same radius. As such, in some embodiments, the channels 106 on the underside 104 of the body 102 might not all be in the same plane, might not be parallel to one another, and might not all have the same radius of curvature.

Adjacent ones of the channels 106, which correspond to adjacent ones of the rollers 930, are spaced by a certain distance L which, when measured in terms relative to a common radius of curvature R of the channels, may correspond to more than twice the radius of curvature R (i.e., more than 200% of the radius of curvature R, denoting an inter-roller gap of close to zero), and may be greater, such as 3 times or even possibly 4 times the radius of curvature R (when the rollers 930 have a gap of almost a full roller between them). For vastly separated channels 106, the mill could be designed with a gap adjustment mechanism so that the rollers 930 can be separated to a suitable distance for cleaning using the cleaning tool 100.

It is noted that materials can transfer from one roller to another during operation, particularly when the roller gap is small. In other cases, material may remain on a roller than is not contacted. As such, in an embodiment, the cleaning tool 100 is designed to cover all rollers of the mill simultaneously. Thus, for the 3-roller ointment mill 900, a 3-channel cleaning tool could be used to minimize the time it takes to clean the rollers of the mill. However, this is not a requirement, and a smaller number of channels may be used.

In the present non-limiting embodiment, and as best seen in FIG. 5, the upper side 108 of the cleaning tool 100 has an undulating surface with troughs/valleys 142 between the channels 106. One or more one apertures 140 (e.g., slits) may be formed in the body 102 to allow liquid (e.g., cleaning fluid) to be dispensed through to the underside 104 of the body 102 and reach (e.g., soak) the cleaning element 700. The cleaning fluid may be a solvent such as water or alcohol. The apertures 140 may be formed in at least one of the troughs 142 to enable cleaning fluid dispensed onto the upper side 108 of the body 102 to leak through the apertures 140 without flowing over the edges of the body 102. As such, it may be desirable in some embodiments for the cleaning element 700 to be permeable to solvent liquids to facilitate cleaning.

In this regard, the cleaning element 700 may be a cloth, as in the illustrated embodiments of FIGS. 7A to 7C. The cloth may be made of any suitable material that allows absorption, retention and/or displacement of the roller residue. For example, the cloth may be a microfiber made of polyester, polyamides, or a combination thereof (e.g., 80% polyester and 20% polyamides), to name a few non-limiting examples. The cloth may be rectangular and may be of an area dimension larger than the underside 104 of the body 102. This is to allow the cleaning element 700 to be wrapped around the underside 104 of the body 102 and attached thereto via the attachment assembly 110. Also, by covering a large surface of the rollers 930 with the cloth, this may potentially prevent improper cleaning, damage to the mill rollers and damage to the cloth itself. Suitable non-limiting examples of dimensions for the cloth may be between 100 and 400 mm per side (for example, 280 mm×210 mm).

The cloth 700 may have any suitable thickness so as to be thick enough to perform the intent of cleaning and not get stuck or pinched between the rollers 930. A suitable thickness may be, for example, between 2 mm and 10 mm or more, including 4 mm. In various non-limiting embodiments, the cloth 700 may have a grammage of between 100 and 400 gsm (grams per square meter), including 270 gsm, for example.

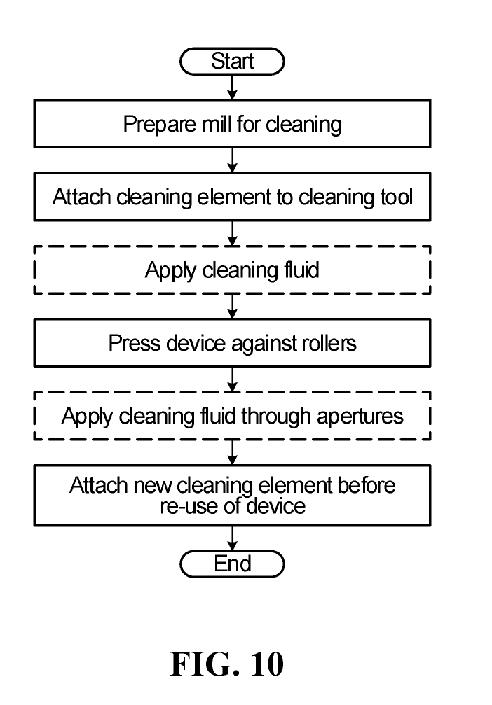

A method of using the device 800 (including the cleaning tool 100 and the cleaning element 700) to perform a cycle of cleaning the rollers of a mill, such as the ointment mill 900, is now described with reference to the flowchart in FIG. 10.

Firstly, a user prepares the mill for cleaning, which in the case of the ointment mill 900 could involve removing the hopper from the mill 900. The mill 900 can then be run at a medium to low speed with minimum gap settings (i.e., front=0, rear=0) in order to recover residual cream on the apron 920. Water or 70% IPA can be used to wet the rollers 930 during this process. The end roller guides (not shown) and the apron 920 are then removed. The mill 900 can then be set to maximum gap and low speed. As persons skilled in the art will know, not all mills have adjustable speed settings, and so it should be understood that it is still possible for the cleaning tool to function with different speeds and gap settings (e.g., higher speeds and lower gap settings).

In addition, the user attaches the cleaning element 700 (e.g., the cloth) to the body 102 of the cleaning tool 100. For example, as shown in FIG. 8A, the user places the underside 104 of the body 102 onto the cloth 700, then (as shown in FIG. 8B) folds the cloth 700 over the periphery of the body 102 to insert at least one of the pegs 112 into the corresponding holes 702, and (as shown in FIG. 8C) continues the process for the other holes and pegs. This yields a fully assembled device 800. The first two pegs 112 to be inserted through corresponding holes may be the center ones in each row of three, as shown in FIG. 8B. This may be beneficial when the distance between the center ones is greater than the difference between corresponding holes in the other rows (i.e., X2 versus X1 as seen in FIG. 7B), as it allows attachment of the looser fitting portion of the cleaning element 700 first. However, this order of attachment is not a requirement, and in other embodiments, the holes 702 may be wrapped around the pegs 112 in a different order.

Then, the user presses the device 800 against the rollers 930 to cause the cleaning element 700 to capture residue from the rollers 930. Residue may include cream, gels, aggregates, solid particles, ointment, liquids and mixtures of base and active pharmaceutical ingredient (API). Before re-use of the device 800 during a new cleaning cycle, a new cleaning element 700 is attached to the cleaning tool 100.

In some embodiments, the ointment mill 900 may have projections 901 that the user may use to stabilize the device 800. The user may thus insert the device 800 so that the projections 901 occupy one of the troughs/valleys 142.

During the cleaning process, cleaning fluid may be applied to the cleaning element 700 through the vertically extending apertures 142 in the body 102 of the cleaning tool 100. The cleaning fluid may be a solvent such as water or alcohol (e.g., 70% IPA), depending on the recommendations of the manufacturer of the rollers being cleaned. The cleaning fluid may be dispensed in any suitable way, including using laboratory glassware (beakers, flasks, bottles, jars, test tubes, cups, pipettes, funnels, etc.), a rubber bulb, a measured transfer device (syringe, pumps, etc.), laboratory wash bottles, etc.

It should also be appreciated that the solvent may be pre-applied to the rollers 930 before use of the device 800, although adding solvent through the apertures 142 in the body 102 of the cleaning tool 100 may be done at a faster rate and without interrupting the cleaning process.

The required amount of time for cleaning the rollers 930 may vary depending on the type of material, and the size, of the rollers 930. In some cases, one (1) minute of cleaning may be adequate, while in other cases, less than one minute and down to 30 seconds or less may suffice and in other cases, more than one (1) minute and up to two (2) minutes or more may be required to achieve adequate cleaning.

It should be appreciated that the device 800 has a length which may be less than or equal to a length of the rollers 930. When it is less than the length of the rollers, the device 800 may be manually slid across the length of the rollers 930 during cleaning so as to ensure that residue is picked up along the length span of the rollers 930.

After use, the device 800 is removed from the rollers 930. In the case where the projections 901 were placed into the troughs/valleys 142, some user manipulation may be needed to remove the device 800 from the stabilizing hold of the projections 901.

After use, the user removes the cleaning element 700 from the body 102 of the cleaning tool 100. This can be done by, for example, raising the cloth 700 vertically until one or more of the pegs 112 slip out of their respective holes 702. At this point, the cloth 700 will be loose enough to remove from the body of the cleaning tool 100.

The spent cleaning element 700 may be discarded or washed, depending on a type of the residue collected. For example, in the case of a hazardous residue, the cloth 700 may be discarded. In the case of a non-hazardous residue, the cloth 700 may be washed and re-used. The maximum number of re-uses may depend on the quality of the cloth 700 and may be up to 20 or more.

Those skilled in the art will appreciate that in other applications, the body of the cleaning tool 100 may have any shape, not necessarily one that projects to a substantially rectangular shape as in FIG. 4. Depending on the shape of the body of the cleaning tool 100, suitable changes would need to be made to the cleaning element 700 (e.g., the cloth). Also, the material of the cloth 700 could be a function of both the material of the rollers 930 and the substance being milled. Example, milling paints on a stainless steel roller will mandate the use of a different fabric than milling an ointment on a porcelain roller. Persons skilled in the art will find it within their purview to base their choice of material for the cleaning element 700 on factors such as viscosity, rheology, and chemical properties of the milled materials.

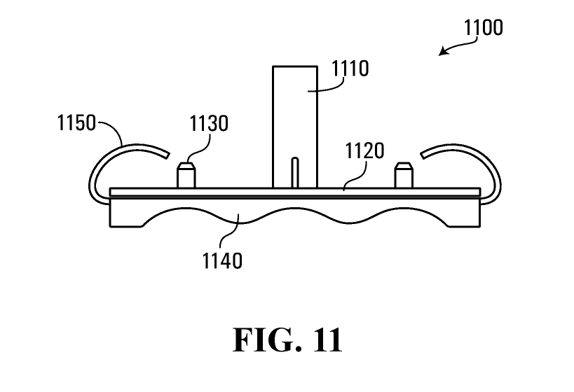

Furthermore, those skilled in the art will appreciate that in an alternative embodiment, and as seen in FIG. 11, there is provided a fully assembled device 1100 which has a cleaning tool and a cleaning element. The cleaning tool comprises a body 1120 incorporating a handle 1110. The cleaning element may include a block 1140 with wings 1150.

The underside of the body 1120 may have a certain shape that does not include a plurality of parallel channels (e.g., it may be flat); rather, the block 1140 may have an upper surface that is complementary to the shape of the underside of the body 1120 (e.g., flat), and a lower surface that has the plurality of parallel channels. In this alternative embodiment, the wings 1150 of the cleaning element amount to the portions of the cleaning element 700 that fold over the edges of the body of the cleaning tool and are secured to each other or to the body (e.g., via pegs 1130). In an embodiment, the block 1140 may be made of a sponge-like absorbent material.

The device 800 (or 1100) may be included with the mill 900 when the mill 900 is sold. Alternatively, the device 800 (or 1100) may be sold separately. In that regard, it should be appreciated that the cleaning tool 100 may be sold or distributed separately from or together with the cleaning element 700, and the cleaning element 700 may itself be sold or distributed in packages of 5, 10 or more.

Different colored cleaning tools 100 and/or handles 130 may be provided so that a pharmacist or other user can color code which tool to use with a specific compound or type of compound.

Those skilled in the art will appreciate that the use of the device 800 (or 1100) described above to clean rollers of a mill may have safety advantages, such as potentially helping to avoid workplace injuries resulting from body parts or clothing being caught in between the rollers while the mill is turning.

Those skilled in the art should appreciate that further realizations and variants are possible, and that certain embodiments may omit certain elements described above, all within the scope of the invention, which is defined by the claims appended hereto.

We claim:

1. A cleaning tool for cleaning rollers of a mill, comprising:
a body with an underside defining a plurality of curved channels; and
an attachment assembly to releasably secure a cleaning element to the body so as to cover the underside thereof when secured.

2. The cleaning tool defined in claim 1, wherein the attachment assembly is affixed to the body.

3. The cleaning tool defined in claim 2, the body having an upper side opposite the underside, the attachment assembly projecting from the upper side of the body.

4. The cleaning tool defined in claim 1, the body having an upper side opposite the underside, the cleaning tool further comprising a handle attached to the upper side of the body.

5. The cleaning tool defined in claim 1, the body having an upper side opposite the underside, wherein the upper side has an undulating surface with troughs between the channels.

6. The cleaning tool defined in claim 5, wherein the upper side includes at least one aperture in at least one of the troughs for allowing liquid dispensed into the trough to reach the underside of the body.

7. The cleaning tool defined in claim 1, the body having an upper side opposite the underside, the attachment assembly being integral with the upper side of the body.

8. The cleaning tool defined in claim 1, the attachment assembly being absent from the underside of the body.

9. The cleaning tool defined in claim 1, wherein the plurality of curved channels are parallel and shaped to accommodate a corresponding plurality of parallel spaced-apart rollers.

10. The cleaning tool defined in claim 1, wherein the underside has an undulating surface.

11. The cleaning tool defined in claim 1, wherein the plurality of channels includes at least three channels in a common plane.

12. The cleaning tool defined in claim 1, wherein the channels have a common radius of curvature and have a depth that that is less than the radius of curvature.

13. The cleaning tool defined in claim 12, wherein a ratio of the depth of the channels to the radius of curvature is between 50% and 95%.

14. The cleaning tool defined in claim 13, wherein a ratio of the depth of the channels to the radius of curvature is between 60% and 80%.

15. The cleaning tool defined in claim 1, wherein the channels have a common radius of curvature and wherein adjacent ones of the curved channels are spaced apart by more than 200% and less than 400% of the radius of curvature.

16. A device for cleaning rollers of a mill, comprising:
a cleaning tool comprising a body;
a cleaning element configured to conform to a shape of a top portion of the rollers; and
an attachment assembly to releasably secure the cleaning element to the body so as to cover an underside thereof when secured.

17. The device defined in claim 16, wherein the underside of the body comprises a plurality of parallel curved channels corresponding to the top portion of the rollers.

18. The device defined in claim 17, wherein the cleaning element comprises a flexible layer of material.

19. The device defined in claim 16, wherein the body of the cleaning tool comprises a periphery between the underside and the upper side, wherein the cleaning element folds around at least part of the periphery to attach to the attachment assembly.

20. The device defined in claim 19, wherein the attachment assembly of the cleaning tool comprises a plurality of pegs and wherein the cleaning element comprises a plurality of holes configured to receive the pegs to secure the cleaning element to the body.

21. The device defined in claim 20, wherein when the upper side is divided into a matrix of 4×4 parts of equal area, each of the four extreme corners of the matrix includes at least one of said pegs.

22. The device defined in claim 16, wherein the cleaning element has a greater surface area than the underside of the body.

23. The device defined in claim 16, wherein the cleaning element is a cloth.

24. The device defined in claim 23, wherein the cloth has a thickness of between 2 and 10 mm.

25. The device defined in claim 23, wherein the cloth comprises microfiber material made of a combination of polyester and polyamides.

26. The device defined in claim 16, wherein the attachment assembly is integral with the body of the cleaning tool.

27. The device defined in claim 16, wherein the attachment assembly is not part of the body of the cleaning tool.

28. The device defined in claim 16, wherein the attachment assembly comprises a first component that affixes to a first part of the cleaning element and a second component that affixes to a second part of the cleaning element.

29. A method of cleaning a plurality of rollers of an ointment mill, comprising:
attaching a cleaning element to a cleaning tool with an underside having curved channels conforming to a surface of the rollers;
pressing the cleaning tool against the rollers to cause the cleaning element to capture residue from the rollers;
removing the cleaning element from the cleaning tool; and
attaching a new cleaning element to the cleaning tool for re-use of the cleaning tool.

30. The method defined in claim 29, further comprising introducing a solvent through apertures in a body of the cleaning tool.

31. The method defined in claim 30, further comprising applying solvent to the cleaning element through the apertures.

32. The method defined in claim 29, further comprising:
attaching the cleaning tool to the ointment mill after the attaching of the cleaning element to the cleaning tool; and
detaching the cleaning tool from the ointment mill before the removing of the cleaning element from the cleaning tool.

33. A device for cleaning rollers of a mill, comprising:
a cleaning tool comprising a body with an underside;
a cleaning element with an upper surface and a lower surface; and
an attachment assembly to releasably secure the upper surface of the cleaning element against the underside of the body;
wherein the lower surface of the cleaning element defines a plurality of curved channels when the upper surface of the cleaning element is secured against the underside of the body.

34. The device defined in claim 33, wherein the lower surface of the cleaning element is preconfigured to include the plurality of curved channels.

35. The device defined in claim 34, wherein the upper surface of the cleaning element is flat, including when the upper surface of the cleaning element is secured against the underside of the body.

36. The device defined in claim 33, wherein the underside of the body is flat.

37. A kit, comprising:
a mill comprising a plurality of parallel rollers with an exposed portion; and
a cleaning tool with a releasably securable cleaning element, the cleaning element having a lower portion with a shape corresponding to a shape of the exposed portion of the rollers.

38. The kit defined in claim 37, wherein the mill is an ointment mill.
